(19) United States
(12) Patent Application Publication
(10) Pub. No.: US 2023/0194033 A1
(43) Pub. Date: Jun. 22, 2023

(54) EXPANSION PLUG ASSEMBLY

(71) Applicant: Dana Motion Systems Italia S.R.L., Reggio Emilia (IT)

(72) Inventor: Piergiorgio Trinchieri, Reggio Emilia (IT)

(21) Appl. No.: 18/068,364

(22) Filed: Dec. 19, 2022

(30) Foreign Application Priority Data
Dec. 20, 2021 (DE) 20 2021 106 906.6

(51) Int. Cl. F16L 55/13

(52) U.S. Cl. CPC F16L 55/13

(57) ABSTRACT

The present disclosure relates to an expansion plug assembly, comprising a body with a channel to be plugged, the channel being defined by a channel wall which has a circumferential groove, a diameter of the groove being larger than a diameter of the channel, and a bushing for inserting into the channel of the body. The bushing comprises an orifice with a partially surrounding bushing wall, the bushing wall having a first bushing wall section having at least a bendable fin for forming a form-fit connection with the circumferential groove, and a tapered pin configured to bend up the bendable fin when inserted into the orifice of the bushing such that the bendable fin forms the form-fit connection with the circumferential groove when the bushing is inserted into the channel.

### CROSS-REFERENCE TO RELATED APPLICATION

The present application claims priority to German Utility Model Application No. 20 2021 106 906.6, entitled “EXPLANSION PLUG ASSEMBLY”, filed on Dec. 20, 2021. The entire contents of the above-listed application is hereby incorporated by reference for all purporses.

### TECHNICAL FIELD

The present disclosure relates to a safety expansion plug assembly for closing connection holes in bodies or manifolds containing a hydraulic circuit.

### BACKGROUND AND SUMMARY

Known expansion plugs used in bodies or manifolds of hydraulic circuits are based on the principle of increasing a frictional resistance between the plug bushing and the hole in a body or manifold by creating a small interference between the circumference of the plug bushing and the circumference of the hole whereby the plug sticks firmly in the hole. When the pressure increases to high values and hydraulic fluid is lost, the plug can nevertheless be ejected from the hole. The ejection pressure of the plug is quite variable depending on the materials used, the clearance and the finishes of the mechanical processing of the plug bushing and the wall surrounding the hole of the body or manifold.

An expansion plug for closing an oil channel 200 of a body or manifold 100 as known in the art is shown in FIGS. 1A and 1B. The plug consists of a bushing 300 and a ball 500. The bushing 300 has external circumferential grooves 600. When the ball 500 is inserted into the bushing 300 and is driven towards the bottom 700 of the bushing orifice 400, the bushing diameter is enlarged creating an interference with the wall of the channel 200. The grooves 600 on the outside of the bushing 300 are planted in the material of the channel wall in the body or manifold 100 creating a mechanical seal to prevent the oil in the body or manifold 100 from escaping and to provide for a certain resistance to expulsion of the plug.

FIGS. 2A and 2B show another plug that is known in the art. The plug of FIGS. 2A and 2B is similar to that of FIGS. 1A and 1B, but has a conical pin 500′ in place of the ball 500 which must be pressed inside the conical channel 200′ of the bushing 300′.

FIGS. 3A and 3B show yet another plug that is known in the art. The plug of FIGS. 3A and 3B is similar to that of FIGS. 2A and 2B except that the pressing of the conical pin 500″ is performed in traction and not in compression by using an applicator 800″ that hooks to the narrow part of the conical pin 500″. The applicator 800″ is cut after the pin 500″ has been fully pressed into the channel 200″.

The mentioned plugs of the state of the art have an unpredictable ejection threshold that depends on the pressure of the fluid and the materials of the body or manifold and the plug, the coupling clearance before the pressing, and the surface roughness of the used materials. Thus, the plugs known in the state of the art are not suitable for reliably closing a fluid channel when the fluid pressure increases.

An object of the present disclosure is to solve the above mentioned problems of the state of the art and to provide an expansion plug assembly with increased safety at high pressure in that it prevents an ejection of the plug assembly if the pressure on the plug assembly increases.

The above object is achieved by an expansion plug assembly as disclosed herein. Embodiments of the expansion plug assembly are described in the dependent claims.

An expansion plug assembly according to the present disclosure comprises a body with a channel to be plugged, the channel being defined by a channel wall which has a circumferential groove, a diameter of the groove being greater than a diameter of the channel, a bushing for inserting into the channel of the body, the bushing comprising: an orifice with a partially surrounding bushing wall, the bushing wall having a first bushing wall section having at least a bendable fin for forming a form-fit connection with the circumferential groove, and a tapered pin configured to bend up the bendable fin when inserted into the orifice of the bushing such that the bendable fin forms the form-fit connection with the circumferential groove when the bushing is inserted into the channel.

Compared to the previously known plugs, the presently proposed expansion plug assembly has an additional safety feature that prevents the bushing to be ejected from the channel under an increase of the fluid pressure. The additional safety feature is formed by the combination of the circumferential groove in the channel wall and the bendable fin in the bushing wall, wherein the bendable fin and the groove form a form-fit connection that prevents the bushing from being ejected when the fluid pressure in the channel increases. The ejection threshold of present expansion plug is thus less sensitive to the material resistance, coupling clearances and surface roughness of the used materials.

In an embodiment, the bushing may further comprise a second bushing wall section for forming a frictional connection with the channel wall.

In an embodiment, the first bushing wall section may comprise two to ten, for instance four to eight or six, bendable fins disposed circumferentially around the orifice. A higher number of fins facilitates insertion of the pin into the bushing and improves the stability of the expansion plug assembly against ejection of the bushing at higher fluid pressure.

In an embodiment, the second bushing wall section may be tapered. This facilitates an insertion of the pin into the bushing and the formation of the form-fit connection between the fin and the groove.

In an embodiment, an inner surface of the bushing wall may be tapered. This facilitates a bending of the fin such that the fin engages with the groove.

In an embodiment, an aperture angle of the second bushing wall section may be smaller than an aperture angle of the inner surface of the bushing wall.

In an embodiment, the orifice is a blind hole and the bushing comprises a bottom wall forming an abutment surface for the pin. The pin thus may form a form-fit connection with the bushing at the bottom wall of the bushing.

In an embodiment, the channel may have a bushing input side, where the bushing can be inserted into the channel, wherein the form-fit connection of the fin and the circumferential groove can be formed at a top abutment edge formed by the circumferential groove on a side of the circumferential groove facing the bushing input side. The pin is thus configured to form a form-fit connection with the bushing at the top abutment edge.

In an embodiment, the channel may have a bushing abutment side, where the bushing abuts when completely inserted into the channel, wherein the channel wall may comprise a bottom abutment edge on the channel abutment side, for forming a form-fit connection with the second bushing wall section.

In an embodiment, the second bushing wall section may comprise a circumferential ridge or a plurality of circumferential ridges configured to form a frictional connection with the channel wall. This frictional connection inhibits the bushing from moving within the channel after being completely inserted into the channel and from being ejected when the pressure of the fluid within the channel increases.

In an embodiment, the circumferential ridge may have a thread shape.

In an embodiment, the pin may have a first pin section with a first taper shape configured to bend up the fin when the pin is completely inserted into the bushing, and a second pin section with a second taper shape configured to expand the second bushing wall section when the pin is completely inserted into the bushing. This facilitates the formation of a form-fit connection between the fin and the groove.

In an embodiment, the first taper shape of the first pin section may have a larger aperture angle than the second taper shape of the second pin section.

In an embodiment, the bushing may comprise or consist of bendable non-thermally treated stainless steel or carbon steel of medium or high.

In an embodiment, the pin may comprise or consist of hardened and/or tempered bearing steels.

The expansion plug assembly according to the present disclosure may be used in various hydraulic products such as pump bodies and motors, mini power packs, blocks, manifolds, and valves.

In the following, an embodiment of the presently proposed expansion plug assembly is described in more detail on the basis of the following figures. The described features are not only conceivable in the combination of the disclosed embodiment, but can be realized independently of the concrete embodiment in various other combinations. In the figures, equal or similar features are denoted by equal or similar reference signs.

### BRIEF DESCRIPTION OF THE FIGURES

FIGS. 1A and 1B show a working principle of an expansion plug according to the state of the art.

FIGS. 2A and 2B show a working principle of another expansion plug according to the state of the art.

FIGS. 3A and 3B show a working principle of another expansion plug according to the state of the art.

FIG. 4 shows a sectional view of a body with a channel of the presently proposed expansion plug assembly according to an embodiment.

FIG. 5 shows a sectional view of a tapered pin partly inserted into a bushing of the presently proposed expansion plug assembly according to an embodiment.

FIG. 6 shows a sectional view of the presently proposed expansion plug assembly according to an embodiment when completely installed.

FIG. 7 shows a perspective view of the presently proposed expansion plug assembly according to an embodiment when completely installed.

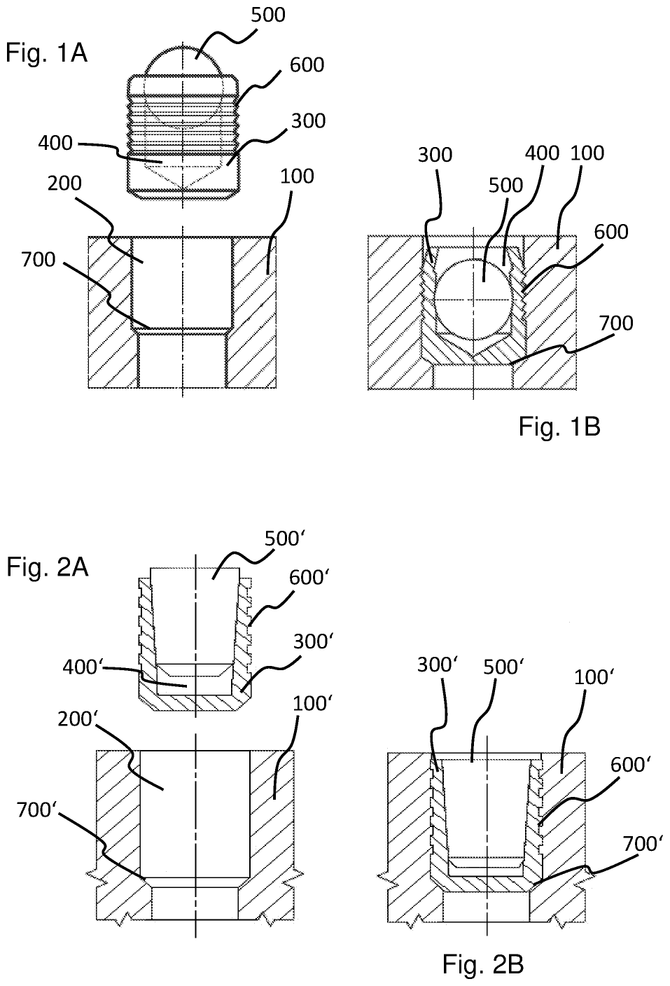

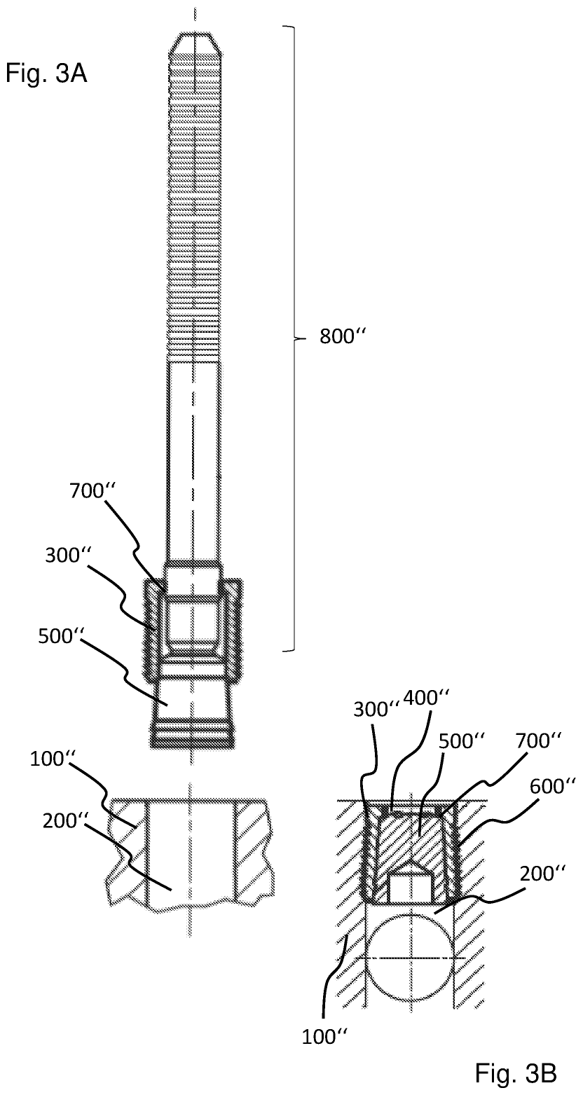

### DETAILED DESCRIPTION

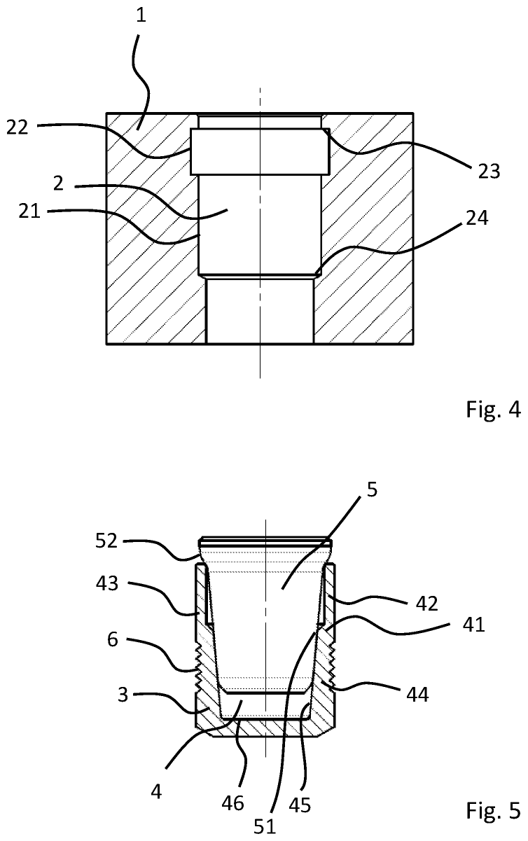

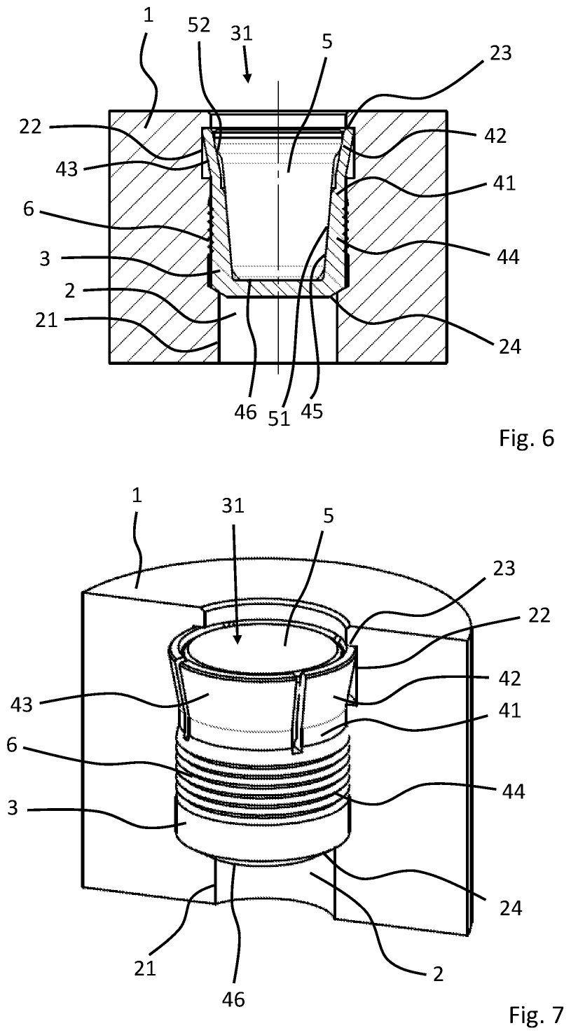

FIGS. 4 to 7 illustrate different aspects of an embodiment of the presently proposed expansion plug assembly. As shown in FIG. 4, the expansion plug assembly comprises a body 1 with a channel 2. The channel 2 may be filled with a fluid that shall be prevented from leaking out of the channel 2 by the expansion plug assembly according to the present disclosure. The channel 2 is surrounded by a channel wall 21. The channel wall 21 comprises a circumferential groove 22 at one side of the channel 2. The groove 22 surrounds a groove section of the channel 2. In the groove section, a diameter of the channel 2 is larger than in a section of the channel 2 adjacent to the groove section. The groove 22 is disposed at a bushing input side 31 (see FIGS. 6 and 7). Spaced apart from the groove 22, the channel wall 21 comprises a bottom abutment edge 24.

As shown in FIG. 5, the expansion plug assembly further comprises a bushing 3 and a pin 5, wherein the pin 5 is adapted to be inserted into the bushing 3. The bushing 3 is adapted to be inserted into the channel 2. The bushing 3 has an orifice 4 with a partially surrounding bushing wall 41. The bushing wall 41 has a first bushing wall section 42 comprising bendable fins 43, for example four bendable fins 43, and a second bushing wall section 44 comprising a plurality of ridges 6. An inner surface 45 of the bushing wall has a taper shape, wherein the taper opens towards the first bushing wall section 42. At a bottom of the orifice 4 next to the second bushing wall section 44, the bushing 3 has a bottom wall 46. The pin 5 has a first pin section 51 with a first taper shape and a second pin section 52 with a second taper shape. The pin 5 can be inserted completely into the bushing 3 such that the pin 5 abuts against the bottom wall 46 of the bushing 3, the first pin section 51 is in frictional connection with the second bushing wall section 44 and the second pin section 52 is in frictional connection with the first bushing wall section 42.

FIG. 6 shows the mounted expansion plug assembly according to the embodiment in a sectional view. FIG. 7 shows the mounted expansion plug assembly according to the embodiment in a perspective view. The bushing 3 has been inserted into the channel 2 from a bushing input side 31. The bushing 3 abuts against the bottom abutment edge 24 of the channel wall 21. The pin 5 has been completely inserted into the bushing 3 such that the pin 5 abuts against the bottom wall 46 of the bushing 3. In this case, the second pin section 52 is disposed next to the first bushing wall section 42 with the fins 43. The fins 43 are bent open by the second pin section 52 having a maximum diameter of the pin 5. Thus, the first bushing wall section 42 increases in diameter, and the fins 43 insert into the groove 22 of the channel wall 21. This results in the formation of a form-fit connection between the fins 43 and the top abutment edge 23 of the groove 22. Thus, the bottom abutment edge 24 and the top abutment edge 23 prevent the bushing 3 from being ejected from the channel 2. Furthermore, the second bushing wall section 44 having a plurality of grooves 6 forms a frictional connection with the channel wall 21 which additionally inhibits a movement of the bushing 3 along the channel 2. The form-fit connection between the fins 43 and the top abutment edge 23 prevents the bushing 3 from being ejected under increased pressure independently of the material resistance, coupling clearances or surface roughness.

1. An expansion plug assembly, comprising:
a body with a channel to be plugged, the channel being defined by a channel wall which has a circumferential groove, a diameter of the circumferential groove being larger than a diameter of the channel,
a bushing for inserting into the channel of the body, the bushing comprising:
an orifice with a partially surrounding bushing wall, the bushing wall having a first bushing wall section having at least one bendable fin for forming a form-fit connection with the circumferential groove, and
a tapered pin configured to bend up the at least one bendable fin when inserted into the orifice of the bushing such that the at least one bendable fin forms the form-fit connection with the circumferential groove when the bushing is inserted into the channel.

2. The expansion plug assembly according to claim 1, wherein the bushing further comprises a second bushing wall section for forming a frictional connection with the channel wall.

3. The expansion plug assembly according to claim 1, wherein the first bushing wall section comprises between two and ten bendable fins disposed circumferentially around the orifice.

4. The expansion plug assembly according to claim 3, wherein the first bushing wall section comprises between four and eight bendable fins disposed circumferentially around the orifice.

5. The expansion plug assembly according to claim 4, wherein the first bushing wall section comprises six bendable fins disposed circumferentially around the orifice.

6. The expansion plug assembly according to claim 2, wherein the second bushing wall section is tapered.

7. The expansion plug assembly according to claim 1, wherein an inner surface of the bushing wall is tapered.

8. The expansion plug assembly according to claim 2, wherein an aperture angle of the second bushing wall section is smaller than an aperture angle of an inner surface of the bushing wall.

9. The expansion plug assembly according to claim 1, wherein the orifice is a blind hole and the bushing comprises a bottom wall forming an abutment surface for the tapered pin.

10. The expansion plug assembly according to claim 1, the channel has a bushing input side, where the bushing is inserted into the channel, wherein the form-fit connection with the circumferential groove is formed at a top abutment edge formed by the circumferential groove on a side of the circumferential groove facing the bushing input side.

11. The expansion plug assembly according to claim 2, wherein the channel has a bushing abutment side, where the bushing abuts when completely inserted into the channel, wherein the channel wall comprises a bottom abutment edge on the bushing abutment side, for forming a form-fit connection with the second bushing wall section.

12. The expansion plug assembly according to claim 2, wherein the second bushing wall section comprises a circumferential ridge configured to form the frictional connection with the channel wall.

13. The expansion plug assembly according to claim 12, wherein the circumferential ridge has a thread shape.

14. The expansion plug assembly according to claim 2, wherein the tapered pin has a first pin section with a first taper shape configured to bend up the at least one bendable fin when the tapered pin is completely inserted into the bushing, and a second pin section with a second taper shape configured to expand the second bushing wall section when the tapered pin is completely inserted into the bushing.

15. The expansion plug assembly according to claim 14, wherein the first taper shape of the first pin section has a larger aperture angle than the second taper shape of the second pin section.

16. The expansion plug assembly according to claim 1, wherein the bushing comprises at least one of a bendable non-thermally treated stainless steel and a carbon steel, of medium-to-high resistance with a bending capacity.

17. The expansion plug assembly according to claim 1, wherein the tapered pin comprises at least one of a hardened bearing steel and a tempered bearing steel.
